(19) United States
(12) Patent Application Publication
(10) Pub. No.: US 2019/0196724 A1
(43) Pub. Date: Jun. 27, 2019

(54) WORKLOAD ALLOCATION ACROSS MULTIPLE PROCESSOR COMPLEXES

(71) Applicant: International Business Machines Corporation, Armonk, NY (US)

(72) Inventors: Preston A. Carpenter, Vail, AZ (US); Gregory E. McBride, Vail, AZ (US); David C. Reed, Tucson, AZ (US); Esteban Rios, Tucson, AZ (US)

(73) Assignee: International Business Machines Corporation, Armonk, NY (US)

(21) Appl. No.: 15/854,618

(22) Filed: Dec. 26, 2017

(51) Int. Cl. G06F 3/06

(52) U.S. Cl. CPC G06F 3/0617; G06F 3/065; G06F 3/0631; G06F 3/0665; G06F 3/067

(57) ABSTRACT

A method for distributing I/O workload across a plurality of processor complexes is disclosed. In one embodiment, such a method includes providing a storage system environment comprising multiple processor complexes. Each processor complex provides access to one or more storage volumes. The processor complexes may be contained within a single storage system or spread across multiple storage systems. Upon allocating data sets in the storage system environment, the method selects storage volumes to store the data sets. In doing so, the method takes into account processor complexes that are associated with each of the storage volumes. More specifically, the method selects storage volumes in a way that more evenly distributes I/O workload across the multiple processor complexes. A corresponding system and computer program product are also disclosed.

### BACKGROUND

### Field of the Invention

This invention relates to systems and methods for distributing workload across a plurality of processor complexes in a storage system environment.

### Background of the Invention

In enterprise storage systems such as the IBM DS8000™, multiple servers may be provided to ensure that data is always available to connected hosts. When one server fails, the other server may pick up the I/O load of the failed server to ensure that I/O is able to continue between hosts and backend storage volumes, which may be implemented on storage devices (e.g. hard disk drives, solid state drives, etc.) within the enterprise storage system. This process may be referred to as a “failover.” To provide the above-described functionality, each server may contain a processor complex (also known as a “central electronics complex”) that includes one or more central processing units (CPUs) and other hardware configured to process I/O requests received from host systems. During normal operation (when both servers are operational), the servers may manage I/O to different logical subsystems (LSSs) within the enterprise storage system. For example, in certain configurations, a first server may handle I/O to even LSSs, while a second server may handle I/O to odd LSSs.

When data sets are allocated on an enterprise storage system such as the IBM DS8000™, a storage volume is typically selected from a pool of storage volumes on the storage system based on which storage volume contains the most (or a significant amount of) available storage space. This selection process typically does not consider other physical characteristics of the storage volume that may be advantageous from a performance perspective. For example, the selection process may not take into account which processor complex is associated with a backend storage volume. As a result, the selection process may result in some processor complexes being burdened with processing significantly more I/O than others.

In view of the foregoing, what are needed are systems and methods to more effectively select storage volumes for allocating data sets. Ideally, such systems and methods will take into account which processor complex is associated with a selected storage volume. This will ideally enable I/O workload to be more evenly distributed across processor complexes in a storage system environment.

### SUMMARY

The invention has been developed in response to the present state of the art and, in particular, in response to the problems and needs in the art that have not yet been fully solved by currently available systems and methods. Accordingly, systems and methods are disclosed to more evenly distribute I/O workload across processor complexes in a storage system environment. The features and advantages of the invention will become more fully apparent from the following description and appended claims, or may be learned by practice of the invention as set forth hereinafter.

Consistent with the foregoing, a method for distributing I/O workload across a plurality of processor complexes in a storage system environment is disclosed. In one embodiment, such a method includes providing a storage system environment comprising multiple processor complexes. Each processor complex provides access to one or more storage volumes. The processor complexes may be contained within a single storage system or spread across multiple storage systems. Upon allocating data sets in the storage system environment, the method selects storage volumes to store the data sets. In doing so, the method takes into account processor complexes that are associated with each of the storage volumes. More specifically, the method selects storage volumes in a way that more evenly distributes I/O workload across the multiple processor complexes.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which a system and method in accordance with the invention may be implemented;

FIG. 2 is a high-level block diagram showing one example of a storage system in which a system and method in accordance with the invention may be implemented;

FIG. 3 is a high-level block diagram showing processor complexes providing access to various storage volumes;

FIG. 4 is a high-level block diagram showing an improved technique for allocating data sets on storage volumes;

FIG. 5 is a high-level block diagram showing processor complexes contained within a single storage system;

FIG. 6 is a high-level block diagram showing processor complexes distributed across multiple storage systems;

FIG. 7 is a high-level block diagram showing skipping over of selected processor complexes that have low storage space; and

FIG. 8 is a high-level block diagram showing an improved technique for striping data sets across storage volumes.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

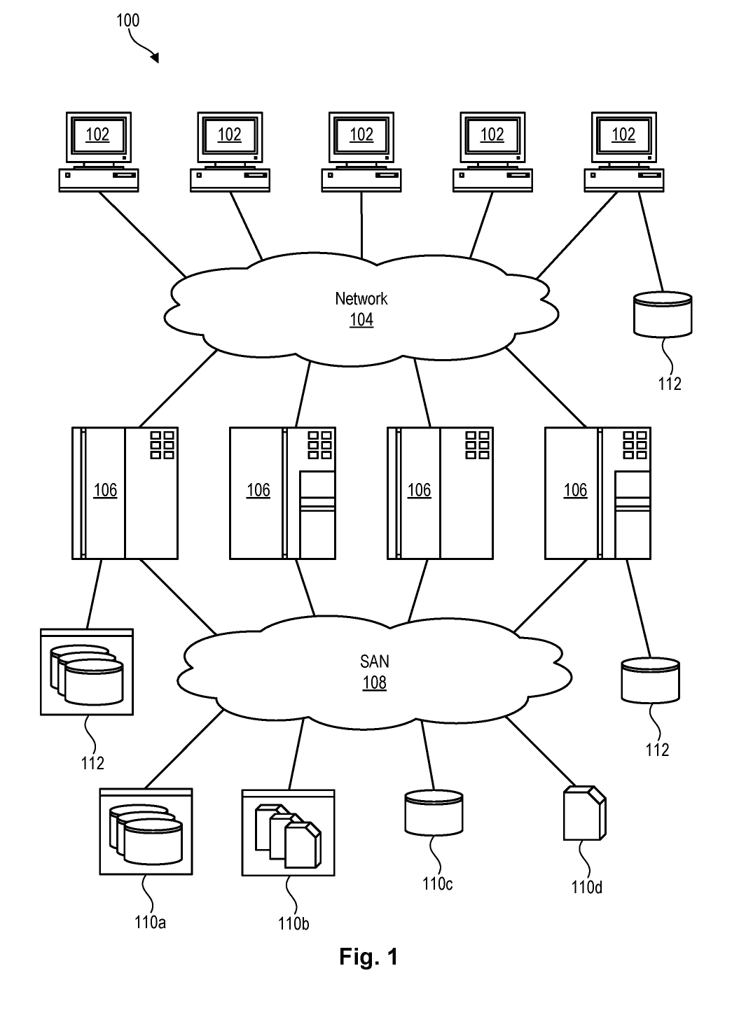

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays of hard-disk drives or solid-state drives, tape libraries, individual hard-disk drives or solid-state drives, tape drives, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC). One or more of the storage systems 110 may utilize the systems and methods disclosed herein.

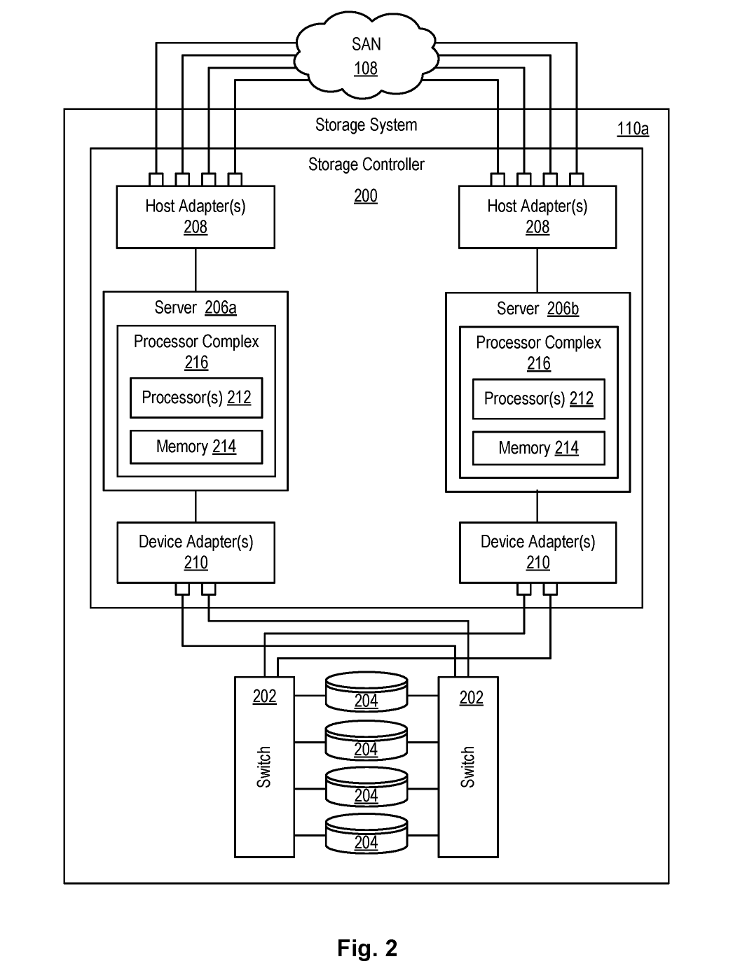

Referring to FIG. 2, one embodiment of a storage system 110a containing an array of hard-disk drives 204 and/or solid-state drives 204 is illustrated. The internal components of the storage system 110a are shown since such a storage system 110a may implement the systems and methods disclosed herein. As shown, the storage system 110a includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

To provide the above-described functionality, each server 206a, 206b may include one or more processor complexes 216 (also known as a “central electronics complexes”) that include one or more central processing units (CPUs) 212 and other hardware (e.g., memory 214) configured to process I/O requests received from host systems 106. During normal operation (when both servers 206a, 206b are operational), the servers 206a, 206b may manage I/O to different logical subsystems (LSSs) within the storage system 110a. For example, in certain configurations, a first server 206a may handle I/O to even LSSs, while a second server 206b may handle I/O to odd LSSs.

One example of a storage system 110a having an architecture similar to that illustrated in FIG. 2 is the IBM DS8000™ enterprise storage system. The IBM DS8000™ is a high-performance, high-capacity storage controller providing disk storage that is designed to support continuous operations. Nevertheless, the systems and methods disclosed herein are not limited to the IBM DS8000™ enterprise storage system 110a, but may be implemented in any comparable or analogous storage system 110a, regardless of the manufacturer, product name, or components or component names associated with the system 110a. Furthermore, any storage system that could benefit from one or more embodiments of the invention is deemed to fall within the scope of the invention. Thus, the IBM DS8000™ is presented only by way of example and is not intended to be limiting.

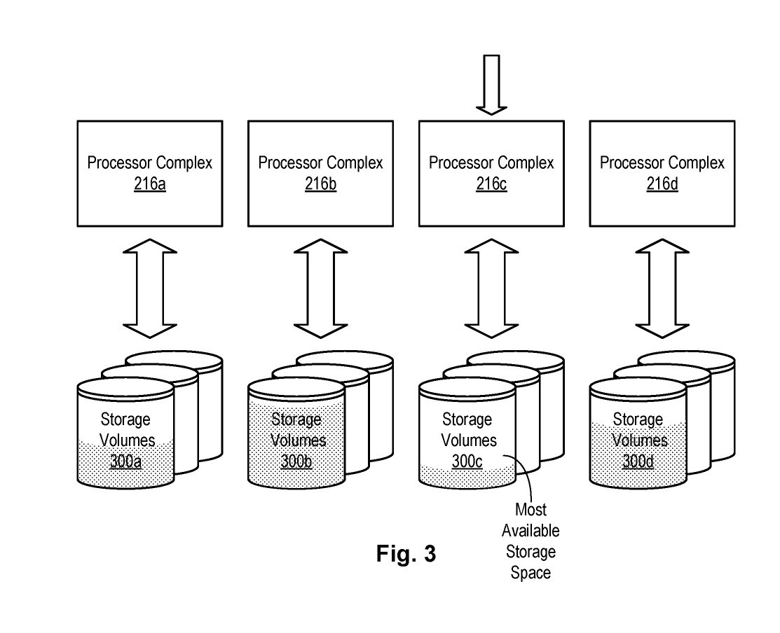

Referring to FIG. 3, when data sets (e.g., files) are allocated on a storage system 110a such as that illustrated in FIG. 2, a storage volume 300c is typically selected from a pool of storage volumes 300a-d on the storage system 110a based on how much space is available in the storage volume 300c. For example, assume that storage volume 300c is selected because it has the most available storage space. This selection process typically does not consider other physical characteristics of the storage volume 300 that may be advantageous from a performance perspective. For example, the selection process may not take into account which processor complex 216c is associated with the backend storage volume 300c. As a result, the selection process may result in some processor complexes being burdened with processing significantly more I/O than others.

As a result, systems and methods are needed to more effectively select storage volumes 300 for allocating data sets. Ideally, such systems and methods will take into account which processor complex 216 is associated with a selected storage volume 300. This will ideally enable I/O workload to be more evenly distributed across processor complexes 216 in a storage system environment.

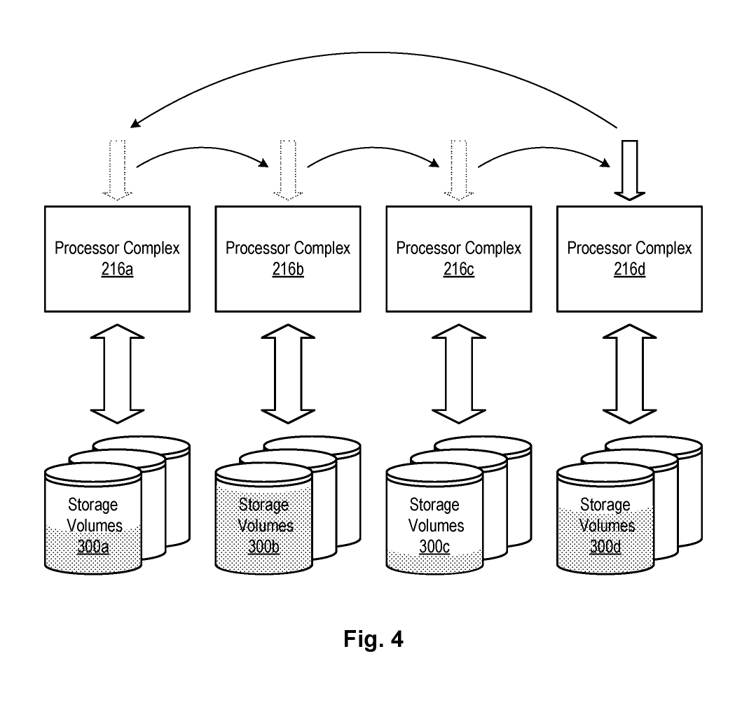

Referring to FIG. 4, a high-level block diagram is provided that shows an improved technique for allocating data sets on storage volumes 300. As shown in FIG. 4, a storage system environment may include a pool of storage volumes 300a-d on which to allocate data sets. As further shown, each of the storage volumes 300a-d may be associated with a processor complex 216 in the storage system environment. The processor complexes 216 that are associated with the storage volumes 300a-d may be taken into account when selecting a storage volume 300 on which to allocate a data set. More specifically, a processor complex 216 and associated storage volume 300 may be selected that more evenly distributes (or attempts to more evenly distribute) I/O across the multiple processor complexes 216.

For example, as shown in FIG. 4, in certain embodiments, a storage volume selection process may alternate between processor complexes 216 in a storage system environment. That is, as data sets are allocated in the storage system environment, the selection process may alternate between storage volumes 300 based on which processor complex 216 they are associated with. As an example, a first data set may be allocated on a storage volume 300a associated with a first processor complex 216a; a next data set may be allocated on a storage volume 300b associated with a second processor complex 216b; a next data set may be allocated on a storage volume 300c associated with a third processor complex 216c; and a next data set may be allocated on a storage volume 300d associated with a fourth processor complex 216d. The selection process may then return to a storage volume 300a associated with the first processor complex 216a to allocate the next data set, and so forth. This selection process may ensure that I/O workload is distributed across the processor complexes 216 in a more even manner.

In certain embodiments in accordance with the invention, the storage volume selection process described above may be enabled for all data sets that are allocated in the storage system environment, for data sets allocated by particular jobs, for particular data sets in the storage system environment, or the like. When a data set extends (grows), the data set may in certain embodiments be configured to extend on the same storage volume 300 on which it was originally allocated, as long as there is room in the storage volume 300. New data set allocations, on the other hand, may be configured to alternate between processor complexes 216 as shown in FIG. 4.

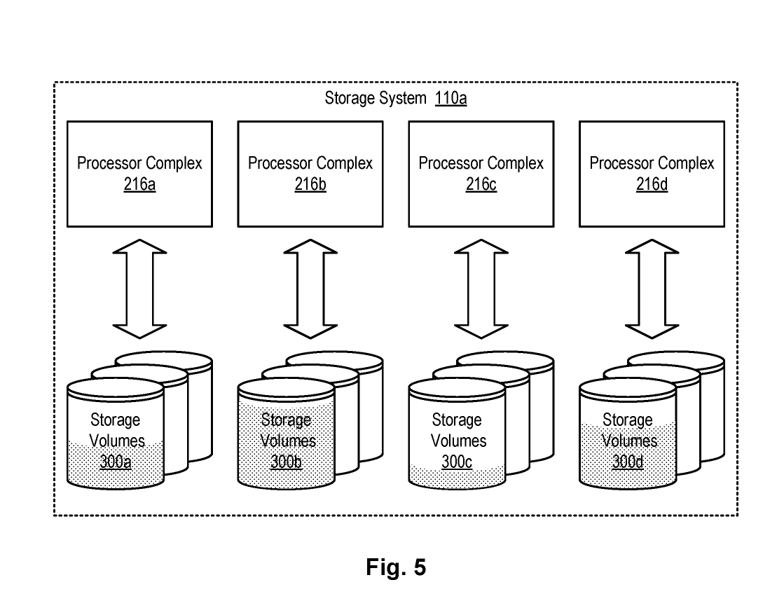

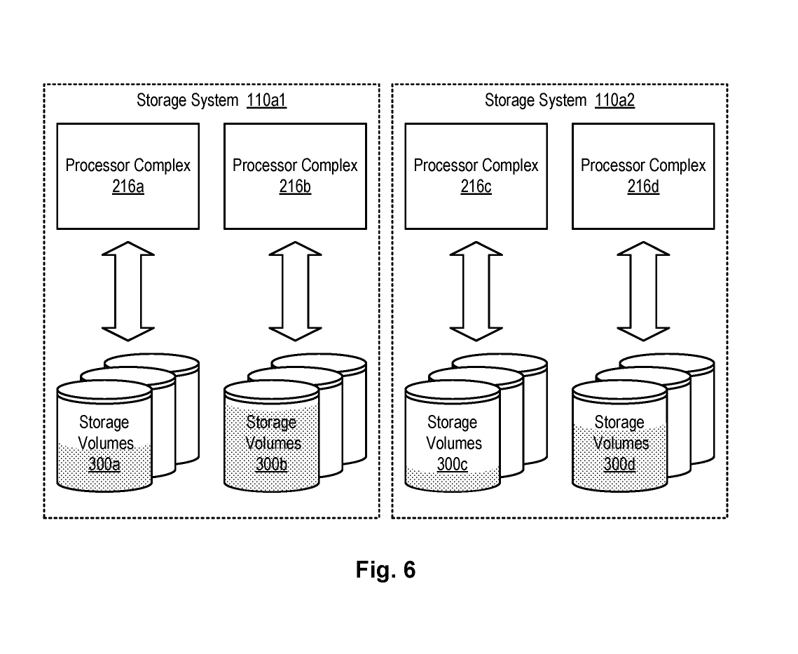

In certain embodiments in the z/OS environment, an option may be added to a storage class to alternate between processor complexes 216 when performing new data set allocations. When routines such as automatic class selection (ACS) routines assign data sets to storage classes, they may be assigned to storage classes that have the option enabled or disabled. The ACS routines may use standard filtering techniques to assign data sets to storage classes, based on characteristics such as data set name, job name, data set high-level qualifier, or other conventional filtering techniques. When a new data set allocation request is received for a storage class with the option enabled, the data set may be allocated on a different processor complex 216 than the previous allocation, in an alternating manner as described in FIG. 4. This selection process may alternate between processor complexes 216 in the same storage system 110a, as shown in FIG. 5, or alternatively between processor complexes 216 in multiple storage systems 110a1, 110a2, as shown in FIG. 6, such as when multiple storage systems 110a1, 110a2 belong to a same storage group.

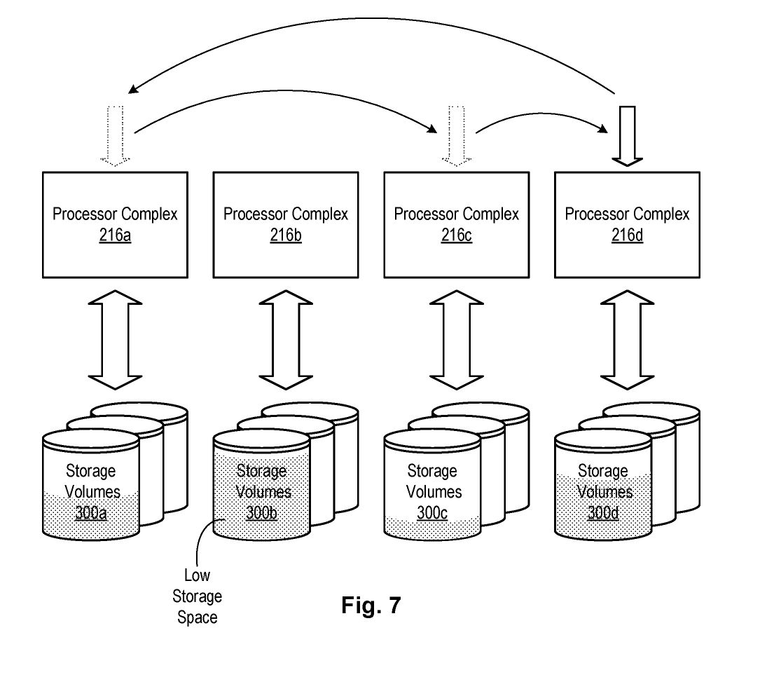

Referring to FIG. 7, in certain embodiments, the storage volume selection process may be configured to skip over processor complexes 216 associated with storage volumes 300 that are low on storage space. For example, as shown in FIG. 7, if storage volume 300b is low on storage space, the selection process may skip over processor complex 216b when allocating data sets to processor complexes 216. This will continue, as much as possible, to balance I/O workload among the remaining processor complexes 216 while not overfilling storage volumes 300 that lack enough storage space.

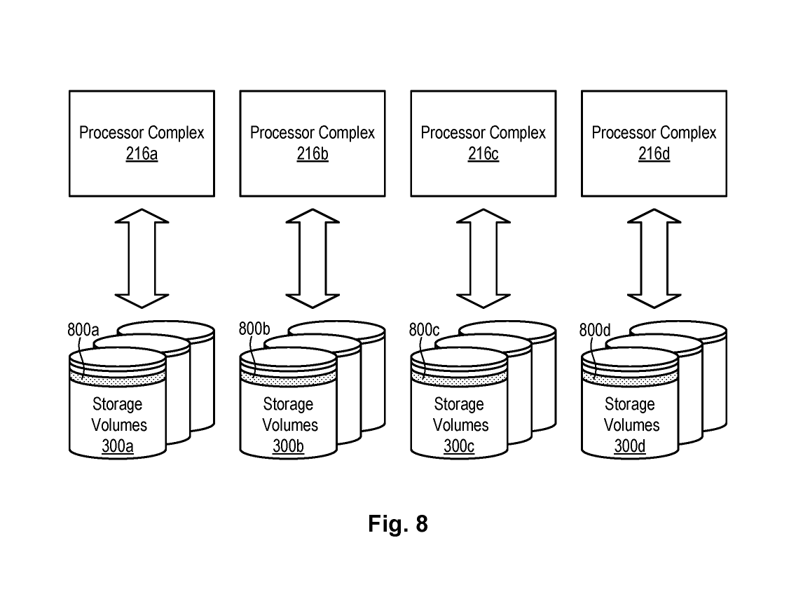

Referring to FIG. 8, in certain embodiments, the storage volume selection process may be extended to the way that striped data sets are distributed across storage volumes 300. A striped data set may be made up of storage elements (e.g., tracks) or groups of storage elements that are distributed across multiple volumes 300. This may be done for performance and/or redundancy reasons. Instead of selecting storage volumes 300 for a striped data set based on which storage volumes 300 have the most available storage space, systems and methods in accordance with the invention may use the alternating volume selection process discussed above. For example, a first stripe 800a of a striped data set may be stored on a storage volume 300a associated with a first processor complex 216a; a second stripe 800b of the striped data set may be stored on a storage volume 300b associated with a second processor complex 216b; a third stripe 800c of the striped data set may be stored on a storage volume 300c associated with a third processor complex 216c; and a fourth stripe 800d of the striped data set may be stored on a storage volume 300d associated with a fourth processor complex 216d. The next stripe may wrap back to the storage volume 300a associated with the first processor complex 216a, and so forth. This may distribute the I/O workload of the striped data set across the multiple processor complexes 216 in a more even manner. Like the previous selection process discussed in association with FIG. 7, this selection process may, in certain embodiments, be configured to skip over processor complexes 216 associated with storage volumes 300 that are low on storage space.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for distributing I/O workload across a plurality of processor complexes in a storage system environment, the method comprising:
providing a storage system environment comprising a plurality of processor complexes, wherein each processor complex provides access to at least one storage volume; and
upon allocating data sets in the storage system environment, selecting storage volumes to store the data sets, wherein selecting storage volumes to store the data sets comprises alternating between the plurality of processor complexes when selecting storage volumes to store the data sets.

2. The method of claim 1, wherein the plurality of processor complexes are contained within a single storage system.

3. The method of claim 1, wherein the plurality of processor complexes are distributed across a plurality of storage systems.

4. (canceled)

5. The method of claim 1, wherein alternating between the plurality of processor complexes comprises skipping processor complexes associated with storage volumes that are running low on storage space.

6. The method of claim 1, wherein selecting storage volumes to store the data sets comprises alternating between the plurality of processor complexes when selecting storage volumes on which to stripe the data sets.

7. The method of claim 1, wherein alternating between the plurality of processor complexes comprises skipping processor complexes associated with storage volumes that are running low on storage space.

8. A computer program product for distributing I/O workload across a plurality of processor complexes, the computer program product comprising a computer-readable storage medium having computer-usable program code embodied therein, the computer-usable program code configured to perform the following when executed by at least one processor:
provide a storage system environment comprising a plurality of processor complexes, wherein each processor complex provides access to at least one storage volume; and
upon allocating data sets in the storage system environment, select storage volumes to store the data sets, wherein selecting storage volumes to store the data sets comprises alternating between the plurality of processor complexes when selecting storage volumes to store the data sets.

9. The computer program product of claim 8, wherein the plurality of processor complexes are contained within a single storage system.

10. The computer program product of claim 8, wherein the plurality of processor complexes are distributed across a plurality of storage systems.

11. (canceled)

12. The computer program product of claim 8, wherein alternating between the plurality of processor complexes comprises skipping processor complexes associated with storage volumes that are running low on storage space.

13. The computer program product of claim 8, wherein selecting storage volumes to store the data sets comprises alternating between the plurality of processor complexes when selecting storage volumes on which to stripe the data sets.

14. The computer program product of claim 8, wherein alternating between the plurality of processor complexes comprises skipping processor complexes associated with storage volumes that are running low on storage space.

15. A system for distributing I/O workload across a plurality of processor complexes, the system comprising:
at least one processor;
at least one memory device operably coupled to the at least one processor and storing instructions for execution on the at least one processor, the instructions causing the at least one processor to:
provide a storage system environment comprising a plurality of processor complexes, wherein each processor complex provides access to at least one storage volume; and
upon allocating data sets in the storage system environment, select storage volumes to store the data sets, wherein selecting storage volumes to store the data sets comprises alternating between the plurality of processor complexes when selecting storage volumes to store the data sets.

16. The system of claim 15, wherein the plurality of processor complexes are contained within a single storage system.

17. The system of claim 15, wherein the plurality of processor complexes are distributed across a plurality of storage systems.

18. (canceled)

19. The system of claim 15, wherein alternating between the plurality of processor complexes comprises skipping processor complexes associated with storage volumes that are running low on storage space.

20. The system of claim 15, wherein selecting storage volumes to store the data sets comprises alternating between the plurality of processor complexes when selecting storage volumes on which to stripe the data sets.
